(19) United States
(12) Patent Application Publication
(10) Pub. No.: US 2021/0219532 A1
(43) Pub. Date: Jul. 22, 2021

(54) STORAGE BOX AND ADAPTOR ASSEMBLY

(71) Applicant: Fiskars Brands, Inc., Middleton, WI (US)

(72) Inventors: Grant Bessac, Beaverton, OR (US); Stephen Lukes, Hillsboro, OR (US); Cheryl Sharp, Portland, OR (US)

(73) Assignee: Fiskars Brands, Inc., Middleton, WI (US)

(21) Appl. No.: 17/248,193

(22) Filed: Jan. 13, 2021

Related U.S. Application Data
(60) Provisional application No. 62/962,625, filed on Jan. 17, 2020.

(51) Int. Cl. A01K 97/06

(52) U.S. Cl. CPC A01K 97/06

(57) ABSTRACT

A storage box includes a container, a cover, and a rail mount. The container has a main body that defines a cavity. The cover is hingedly coupled to the container to allow selective access to the cavity. The rail mount extends away from a bottom surface of the main body. The rail mount is defined by an annular body having at least one dovetail extending radially outward from the annular body.

### CROSS-REFERENCE TO RELATED APPLICATION

This Application claims priority to U.S. Provisional Patent Application No. 62/962,625, filed Jan. 17, 2020, the content of which is hereby incorporated by reference in its entirety.

### BACKGROUND

The present invention relates generally to the field of storage boxes and in particular to the field of fishing tackle storage boxes.

### SUMMARY

At least one embodiment relates a fishing storage box. The fishing storage box includes a container having a main body defining a cavity, a cover, and a rail mount. The cover is hingedly coupled to the container to allow selective access to the cavity. The rail mount extends away from a bottom surface of the main body, and is defined by an annular body having at least one dovetail extending radially outward therefrom. The rail mount can interface with an adapter assembly to mount the fishing storage box to a track rail system on a boat (e.g., a kayak or other fishing boat) in several indexed positions.

At least one embodiment relates to an adapter assembly for mounting an item to a track rail. The adapter assembly includes a rail mount, an adapter body, and a wave spring. The rail mount is defined by an annular body and has at least one dovetail extending radially outward from the body. The adapter body is partially defined by a cylindrical wall circumscribing a body cavity. At least one flute is formed within an inner surface of the cylindrical wall. A lip extends radially inward from the cylindrical wall, angularly offset from the at least one flute. The wave spring is received within the body cavity and includes cantilevered arms that provide a bias away from a base of the adapter body toward the lip. The rail mount is releasably coupled to the adapter body by aligning the at least one dovetail with the at least one flute, moving the rail mount toward the base of the adapter body against the bias of the wave spring until the at least one dovetail is positioned between the base of the adapter body and the lip, and rotating the rail mount to a position where at least a portion of the lip overlaps the at least one flute.

At least one embodiment relates to a method of mounting a storage box on a track rail. The method includes aligning a container of the storage box with an adapter assembly located on the track rail. The method further includes moving the container of the storage box toward the adapter assembly so that at least a portion of a rail mount coupled to the container enters into a cavity of the adapter assembly. The method further includes rotation the container so that a portion of the rail mount engages a portion of the adapter assembly. The engagement between the rail mount and the adapter assembly opposes relative axial movement between the rail mount and the adapter assembly.

At least one embodiment relates to a fishing storage box. The fishing storage box includes a container having a main body defining a cavity and a cover hingedly coupled to the container to allow selective access to the cavity. An organizational cup is removably received within the cavity. The organizational cup is defined by an outer wall surrounding a receptacle, and further includes a line wrap protruding laterally away from the outer wall. The line wrap is at least partially formed of an elastomeric material and is defined by an elongate shape having a line wrapping section and a line securing section. The line securing section is formed outward from and overhangs at least a portion of the line wrapping section. Slits are formed within the line securing section to receive fishing line.

At least one embodiment relates to a fishing storage box. The fishing storage box includes a container, a cover, and an elastomeric insert. The container has a main body and defines a cavity. The cover is hingedly coupled to the container to allow selective access to the cavity. The elastomeric insert is received within the cavity, and is defined by an outer wall surrounding a receptacle. The elastomeric insert further includes a line cleat extending laterally away from the outer wall. The line cleat is at least partially formed of an elastomeric material and is received within and compressed by the main body. The line clean defines a slit to receive fishing line therein.

At least one embodiment relates to a fishing storage box. The fishing storage box includes a container having a main body defining a cavity and a cover hingedly coupled to the container to allow selective access to the cavity. A line cutter assembly is at least partially formed within the main body. The line cutter assembly includes a razor blade removably received within a guard. The guard surrounds at least a portion of the razor blade and selectively permits access to the razor blade by preventing items above a threshold size from contacting the razor blade while allowing items below the threshold size to contact the razor blade.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

The invention will become more fully understood from the following detailed description, taken in conjunction with the accompanying drawings, in which:

FIG. 1 is a top perspective view of a fishing storage box in a closed position, according to an exemplary embodiment.

FIG. 2 is a top perspective view of the fishing storage box of FIG. 1 in an open position.

FIG. 3 a top perspective view of an organizational cup that is present within the fishing storage box of FIG. 1, shown in isolation.

FIG. 4 is a top view of the organizational cup of FIG. 3.

FIG. 5 is a top partial perspective view of a front of the fishing storage box of FIG. 1, depicting a line cutter assembly with a cover of the fishing storage box removed for clarity.

FIG. 6 is a top view of the line cutter assembly of FIG. 5.

FIG. 7 is a top perspective view of a blade of the line cutter assembly of FIG. 5.

FIG. 8 is a front view of the blade of FIG. 7.

FIG. 9 is a bottom perspective view of the fishing storage box of FIG. 1, depicting a rail mount joined to a bottom surface of the fishing storage box.

FIG. 10 is a bottom view of the fishing storage box of FIG. 1.

FIG. 11 is a bottom perspective view of the fishing storage box of FIG. 1, where the rail mount shown in FIG. 9 is coupled to an adapter assembly.

FIG. 12 is a top perspective view of the coupling formed between the rail mount and adapter assembly of FIG. 11.

FIG. 13 is a top view of the coupling of FIG. 12.

FIG. 14 is an exploded view of the adapter assembly of FIG. 11.

FIG. 15 is a top perspective view of the rail mount of FIG. 9, shown in isolation.

FIG. 16 is a top view of the rail mount of FIG. 15.

FIG. 17 is a bottom view of the rail mount of FIG. 15.

FIG. 18 is a front view of the rail mount of FIG. 15.

FIG. 19 is a top perspective view of a wave spring present within the adapter assembly of FIG. 11.

FIG. 20 is a top view of the wave spring of FIG. 19.

FIG. 21 is a front view of the wave spring of FIG. 19.

FIG. 22 is a top perspective view of an adapter body of the adapter assembly of FIG. 11.

FIG. 23 is a bottom perspective view of the adapter body of FIG. 22.

FIG. 24 is a top view of the adapter body of FIG. 22.

FIG. 25 is a cross-sectional view of the adapter body of FIG. 22, taken along line 25-25 shown in FIG. 24.

FIG. 26 is a top perspective view of a collar of the adapter assembly of FIG. 11.

FIG. 27 is a bottom perspective view of the collar of FIG. 26.

FIG. 28 is a top view of the collar of FIG. 26.

FIG. 29 is a top perspective view of a T-bar of the adapter assembly of FIG. 11.

FIG. 30 is a top perspective view of a track rail that can receive and support the adapter assembly of FIG. 11 and rail mount of FIG. 9 to secure the fishing storage box of FIG. 1 upon the track rail.

FIG. 31 is a top perspective view of a fishing storage box in a closed position, according to another exemplary embodiment.

FIG. 32 is a top view of the fishing storage box of FIG. 31, shown in an open position.

FIG. 33 is a top, detailed view of the fishing storage box of FIG. 32, depicting a line cutter assembly.

FIG. 34 is a cross-sectional view of FIG. 33, taken along line 34-34 in FIG. 33.

FIG. 35 is a front view of the fishing storage box of FIG. 31.

FIG. 36 is a front, detailed view of the fishing storage box of FIG. 35, focusing on the line cutter assembly of FIG. 33.

FIG. 37 is a top, detailed view of the fishing storage box of FIG. 32, focusing on an organizational cup received within the fishing storage box.

FIG. 38 is a right, detailed view of the fishing storage box of FIG. 32.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the FIGURES, a storage box is disclosed. The storage box can be a toolbox, cooler, tackle box, or other type of container sufficient to store and house items, including tools, food, and fishing tackle, for example. Although referred to as a fishing storage box throughout, the term “fishing storage box” is intended to encompass containers and storage boxes of any variety, including the above-mentioned coolers, tool boxes, and the like. The fishing storage boxes shown include a variety of different features to help a fisherman or fisherwoman efficiently perform common tasks associated with fishing, including tying on lures, cutting fishing line, and storing lures for later use. The fishing storage box includes a container and a cover that is hingedly coupled to the container to secure and protect items within the container. The container defines one or more compartments that are adapted for receiving fishing tackle. The compartments are formed in a variety of different shapes and sizes to accommodate different tackle sizes and types, and may be removable from the container to improve functionality. For example, one or more of the compartments can be formed as an organizational cup that includes an integrated line wrap that can be used in conjunction with the cup to store lures, fishing line and/or leaders without incurring any unwanted stress or damage to fishing line or leaders. The fishing storage box may also include an integrated line cutter assembly. The line cutter assembly extends outward from the container of the fishing storage box and includes a guard that directs fishing line toward a razor blade while simultaneously restricting larger objects, like a finger, from contacting the razor blade. The container further includes inlayed cleats that can be used to temporarily secure fishing line while fishing line is being cut by the line cutter assembly or when a new lure is being tied or otherwise secured to the fishing line.

The fishing storage box may also include a rail mount that can be removably coupled to an adapter assembly to mount the fishing storage box to a boat or other surface. Specifically, the fishing storage box adapter assembly is configured to be secured along a track rail system, which can extend along a wall or other suitable surface of a canoe, kayak, or other type of boat. The adapter assembly can slide along the track rail until it is located in a desired position along the track rail, where it can then be readily secured by rotating a collar of the adapter assembly. The rail mount, which extends away from the bottom of the container of the fishing storage box, can then be secured to the adapter assembly to couple the fishing storage box to the track rail. The rail mount includes a dovetail geometry that can be secured to the adapter assembly by pushing the fishing storage box (and rail mount) downward into the adapter assembly and then rotating the fishing storage box and rail mount (e.g., 45 degrees) in either direction. The fishing storage box and rail mount can be decoupled from the adapter assembly by rotating the fishing storage box in either direction (e.g., rotating the fishing storage box an additional 45 degrees or negative 45 degrees), which unlocks the rail mount from the adapter assembly. The adapter assembly and rail mount together allow the fishing storage box to be mounted at multiple indexed rotational orientations relative to the adapter assembly.

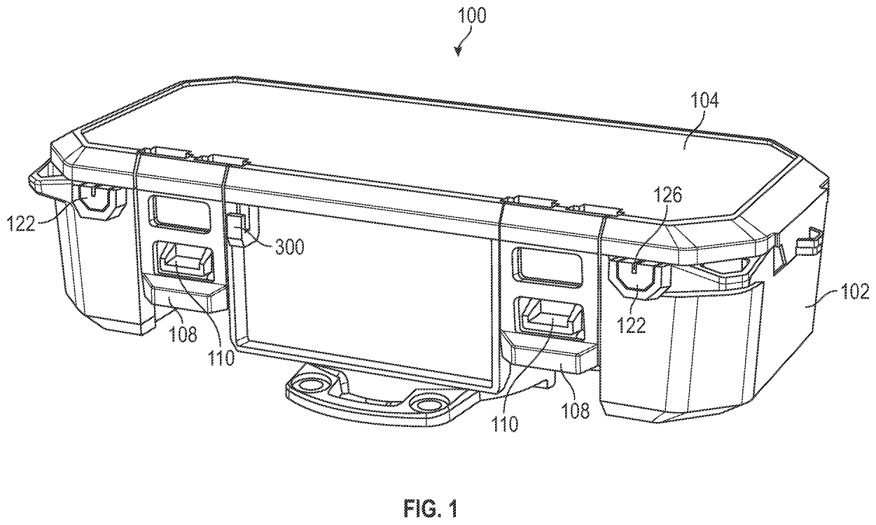

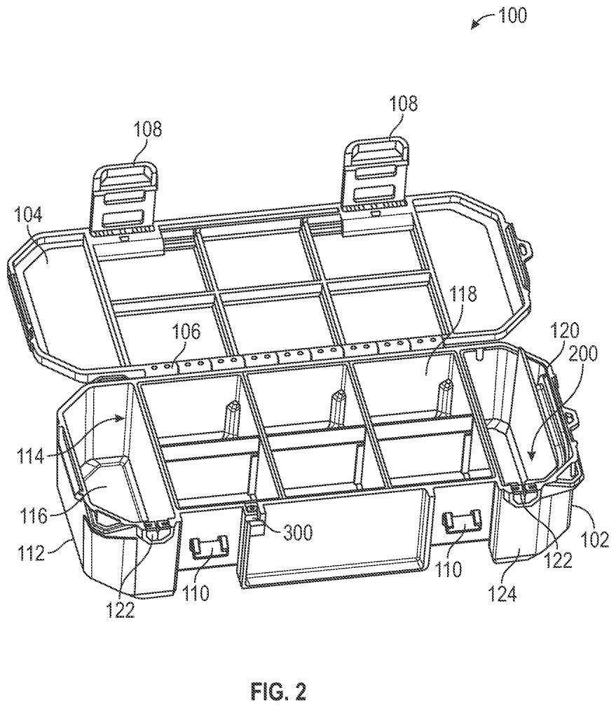

Referring to FIGS. 1 and 2, a fishing storage box 100 is depicted. The fishing storage box 100 generally includes a container 102 and a cover 104 that is hingedly coupled to the container 102 to provide selective access into the container 102 and protect any contents (e.g., fishing tackle, food, tools, etc.) stored within the container 102. A hinge joint 106 can be formed at a rear of the fishing storage box 100 to permit rotation of the cover 104 relative to the container 102 between a closed position (shown in FIG. 1) and an open position (shown in FIG. 2). Latches 108 extending away from the cover 104 can be removably secured to hooks 110 on the container 102 to lock the fishing storage box 100 in the closed position.

The container 102 is generally defined by a rectangular main body 112 that surrounds and defines a cavity 114. As depicted in FIG. 2, the cavity 114 is split into several compartments 116, 118. The compartments 116, 118, 120 can be a variety of different sizes and depths to efficiently store various types of fishing tackle. As explained in detail below, inserts (e.g., an organizational cup 200) can be received within the compartments 116, 118, 120 to facilitate the storing and removal of fishing tackle from the container 102. The main body 112 of the container 102 also includes additional features that can prove useful to a fisherman or fisherwoman while on the water. For example, line cleats 122 in the form of rubber inserts are received within and secured to gaps formed within a front wall 124 of the main body 112. The line cleats 122 define a channel 126 that can provide temporary line-holding assistance during the tying or removal of a lure, swivel, hook, or leader or while cutting line.

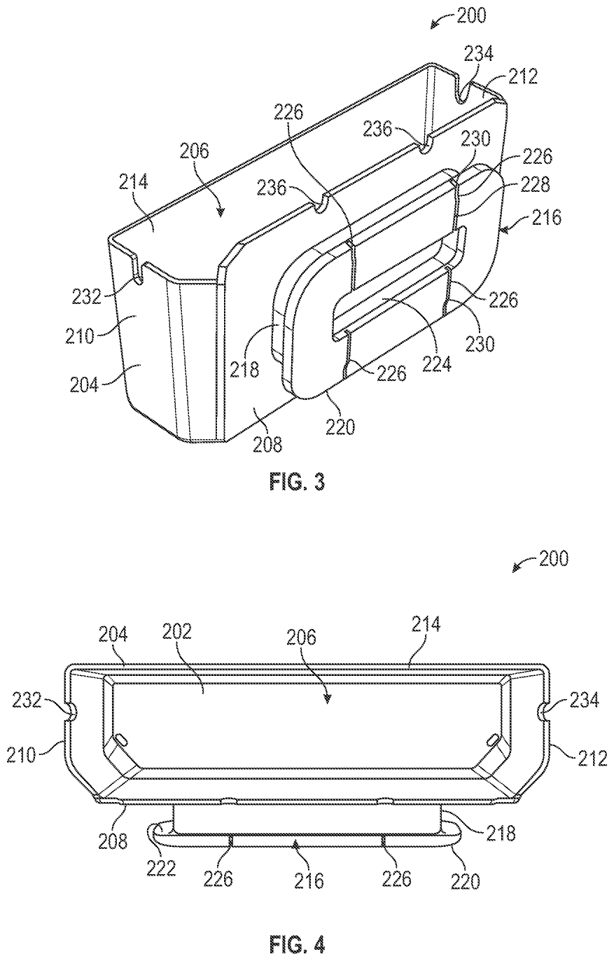

With additional reference to FIGS. 3-4, an organizational cup 200 adapted for use within the container 102 is depicted. The organizational cup 200 is designed to house lures, fishing line, leaders, or other fishing tackle and is dimensioned so that the organizational cup 200 is removably received within one of the compartments (e.g., the compartment 120) in the cavity 114. The removable nature of the organizational cup 200 allows a user to interact with and use features on the organizational cup (e.g., the line wrap 216) when the organizational cup 200 is removed from the fishing storage box 100. As discussed below, the organizational cup is further adapted to interact with additional features of the fishing storage box 100, such as the line cleat 122, to perform tasks commonly associated with fishing.

The organizational cup 200 is defined, generally by a base wall 202 and an outer wall 204 extending upwardly around the base wall 202. The base wall 202 and outer wall 204 collectively define a receptacle 206 for housing and storing fishing tackle. As depicted, the outer wall 204 has a non-uniform height extending around the base wall 202 to define a rectangular receptacle 206. Specifically, a first portion 208 of the outer wall 204 is defined by a height that is greater than a height defining the three remaining portions 210, 212, 214 of the outer wall 204.

The organizational cup 200 further includes a line wrap 216 extending away from the outer wall 204. As depicted in FIGS. 3-4, the line wrap 216 extends laterally away from the taller first portion 208 of the outer wall 204. The line wrap 216 is at least partially formed of an elastomeric material, and is defined by an elongate shape having a line wrapping section 218 and a line securing section 220 positioned at a distal end of the line wrapping section 218 and spaced apart from the outer wall 204. The line securing section 220 is formed outward from and overhangs at least a portion of the line wrapping section 218.

The line wrapping section 218 is defined by a rounded rectangular shape that extends away from the outer wall 204. In some examples, the line wrapping section 218 of the line wrap 216 is formed of the same polymeric material as the outer wall 204, such that the base wall 202, outer wall 204, and line wrapping section 218 can all be formed (e.g., injection molded) as a single, continuous component. In other examples, the line wrapping section 218 and line securing section 220 can be formed as a single, continuous elastomeric component.

The line securing section 220 is also defined by a rounded rectangular shape. However, as depicted in FIGS. 3-4, the rounded rectangular shape of the line securing section 220 is defined by a length and a width that are larger than the length and width defining the line wrapping section 218. In some examples, the line wrapping section 218 and line securing section 220 are each centered around a common location. By centering each of the line wrapping section 218 and line securing section 220 about a common location on the outer wall 204, the size differential ensures that an overhanging lip 222 extends around the entire line wrapping section 218. A rounded rectangular central passageway 224 is formed through each of the line wrapping section 218 and the line securing section 220, terminating at the outer wall 204.

As indicated previously, the line securing section 220 is formed of an elastomeric material that is deformable to help secure fishing lures, leaders, and line for later use. To further facilitate coupling and storing these components on the line wrap 216, a series of slits 226 are formed within the line securing section 220 of the line wrap 216. The slits 226 extend from an outer perimeter of the line wrapping section 220 inward, toward the central passageway 224, and can vary in size and depth. For example, each slit 226 can include a wider and shallower first section 228 extending away from the central passageway 224. The first section 228 can be defined by a depth that is approximately half the thickness defining the line securing section 220. The first section 228 extends toward and tapers inward to a second section 230. The second section 230 extends the rest of the way outward to the perimeter of the line securing section 220, and extends entirely through the thickness of the line securing section 220. The second section 230 of each slit 226 is defined by a width that is smaller than most commonly-used fishing lines (e.g., 0.10 mm) so that each wall defining the slit 226 initially opposes fishing line that is pushed inward, into the slit 226. When a force is provided to the fishing line to overcome the natural bias of the walls of the slit 226, the walls of the slit 226 flex outward, away from a resting position, to allow the line to enter into the slit 226. The walls of the slit engage and secure the fishing line, lure, or leader that is received within the slit 226 as the walls attempt to return to their resting position. As depicted, four slits 226 can be positioned within the line securing section 220 of the line wrap 216, spaced apart but aligned vertically with other slits 226.

The organizational cup 200 also includes a series of pass through slots 232, 234, 236 formed within the first, second, and third portions 208, 210, 212 of the outer wall 204. As depicted, the pass through slots 232, 234, 236 are each formed within a top surface of their respective portions 208, 210, 212 of the outer wall 204, and can be used to define a fishing line or leader path. The pass through slots 232, 234 formed in the second and third portions 210, 212 can be aligned with one of the line cleats 122, for example, so that the fishing storage box 100 can readily receive a line/leader and lure assembly, which can reside primarily within the receptacle 206 of the organizational cup 200. By passing the line or leader through the line cleat 122 and pass through slot 232 and securing the line to the line cleat 122, unwanted tangles or knots within the assembly can be avoided. The pass through slots 236 formed in the first portion 208 of the outer wall 204 provide a similar functionality. The pass through slots 236 are aligned with the slits 226 formed within the line wrap 216, and provide a channel for fishing line or leaders to pass into the receptacle 206 in a manner that reduces the stress on the line or leader.

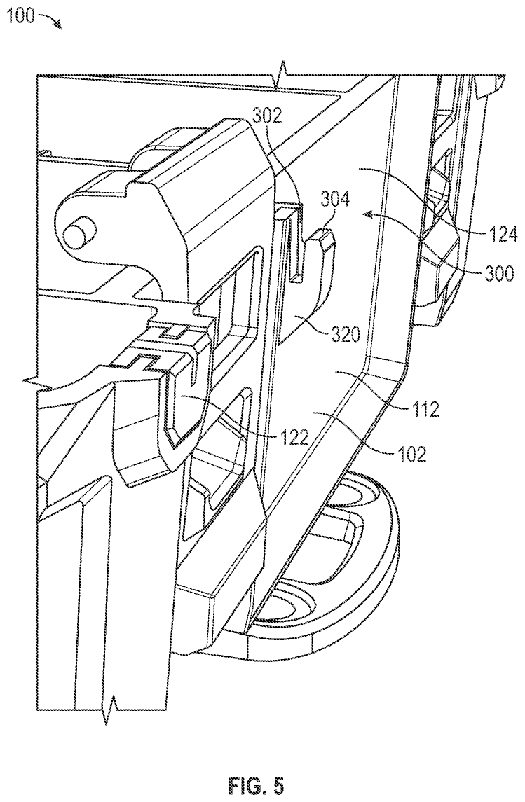

With additional reference to FIGS. 5-8 and continued reference to FIGS. 1-4, a line cutter assembly 300 is depicted extending away from the front wall 124 of the main body 112 of the fishing storage box 100. The line cutter assembly 300 generally includes a razor blade 302 that is received within a guard 304. The guard 304 extends both upwardly and outwardly away from the front wall 124, and surrounds and extends beyond portions of at least three sides of the razor blade 302 so as to limit the exposure and potential contact surface of the razor blade 302. The guard 304 defines a channel 306 that serves as a line passageway to the razor blade 302. The channel 306 is designed so that fishing line (or similarly sized items) can be readily passed into the channel 306 and into contact with the razor blade 302, while larger items (e.g., a human finger) are blocked from entry into the channel 306 and blocked from making contact with the razor blade 302. At least a portion of the line cutter assembly 300 extends outwardly beyond and/or below the cover 104 of the fishing storage box 100 so that the line cutter assembly 300 can be used regardless of whether the cover 104 is opened or closed. While depicted as an upward-extending guard 304 and upward-oriented blade 302 in FIGS. 1-2 and 5-8, downward-extending guards and downward-oriented blades 302 can also be incorporated into the fishing storage box 100 to achieve a similar function.

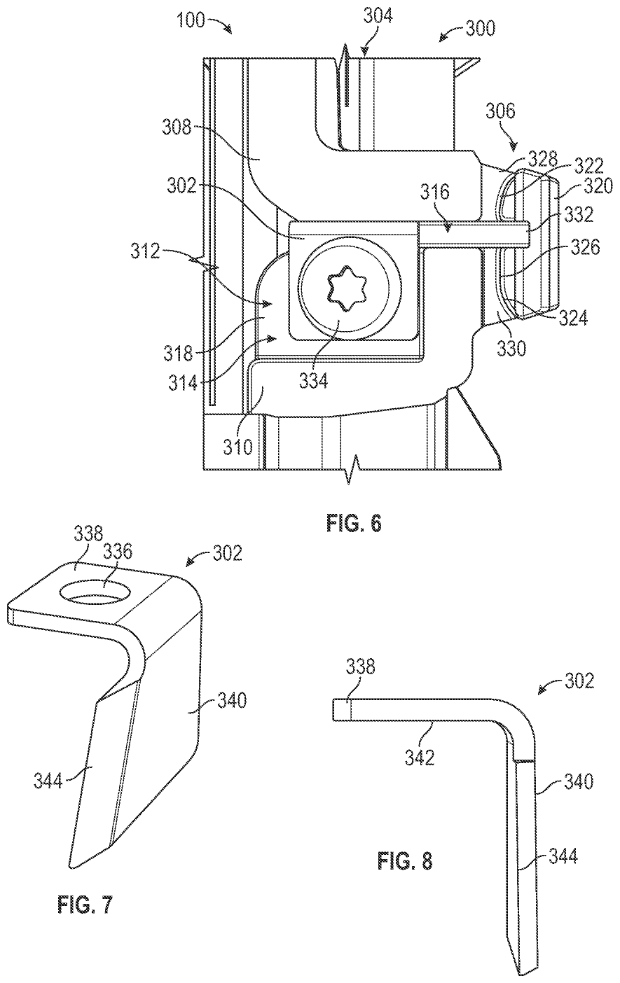

As depicted in FIG. 6, the guard 304 is partially defined by two converging sections 308, 310 of the main body 112. The two converging sections 308, 310 are formed integrally (i.e., continuously) with the main body 112 so that the guard 304 can be considered integrated into the fishing storage box 100. The two converging sections 308, 310 are defined by L-shaped sections that are rotationally offset from one another by 90 degrees to define a blade cavity 312. The blade cavity 312 includes a widened mounting segment 314 formed toward the main body 112 of the container 102 and a narrowed blade segment 316 defining a blade passage extending forward from the main body 112. The mounting segment 314 can be further defined by a seat 318 extending away from the first converging section 308, toward but not entirely to the second converging section 310. The seat 318 creates a mounting surface that can receive and secure a portion of the razor blade 302, as explained in additional detail below.

The guard 304 is further defined by an arm 320 extending away from the two converging section 308, 310. The arm 320 extends outwardly and upwardly away from the converging sections 308, 310 and defines the lower and outer walls of the channel 306. As depicted in FIG. 5, the arm 320 is defined by a hook-like shape protruding from the front wall 124 of the main body 112. Like the converging sections 308, 310, the arm 320 can be integrally formed with the main body 112 of the container 102, so that the guard 304 of the blade assembly 300 can be continuously molded or otherwise formed within the main body 112 of the container 102. The guard 304 and line cutter assembly 300, more generally, can be offset toward one side of the container 102 so as to allow concurrent and efficient use with either of the line cleats 122.

The arm 320 has a variable shape to help direct fishing line inward, into the channel 306 and toward the razor blade 302. As depicted in FIG. 6, the arm 320 includes two tapered sections 322, 324 positioned on opposite ends of the arm 320 to form a line guiding surface 326. The tapered sections 322, 324 define widened openings 328, 330 that can help initially receive fishing line. The tapered sections 322, 324 extend inward toward the converging sections 308, 310 in a way that creates a narrowed, throat-like segment of the channel 306 extending transversely to the razor blade 302. Accordingly, a width of the channel 306 decreases as it approaches the razor blade 302 in both directions. A recess 332 is formed within a central portion of the arm 320, which receives and supports a portion of the razor blade 302. The recess 332 is aligned, generally, with the blade segment 316 of the blade cavity 312 and forms a portion of the blade passage.

The razor blade 302 is received within the blade cavity 312 and the line cutter assembly 300. The razor blade 302 can be removably coupled to the seat 318, for example, so that the razor blade 302 can be removed if it becomes dull or otherwise damaged and needs replacement. For example, a threaded hole (not shown) formed within the seat 318 can receive and secure a threaded fastener 334 extending through a mounting hole 336 formed within the razor blade 302, which removably secures the razor blade 302 to the seat 318.

The razor blade 302, as depicted in FIGS. 7-8, is defined by a continuous body that has a mounting section 338 extending toward a blade section 340. The mounting section 338 provides a flat mounting surface 342 that surrounds and extends away from the mounting hole 336, which extends entirely through the mounting section 338. The mounting section 338 and the blade section 340 extend in different planes. For example and as depicted in FIG. 8, the blade section 340 and mounting section 338 extend approximately perpendicular to one another. In some examples, the razor blade 302 is bent into the perpendicular arrangement depicted in FIGS. 7-8. The blade section 340 includes a sharpened edge 344 formed at a distal end of the razor blade 302. The sharpened edge 344 can extend along an angle of the blade section 340, such that the sharpened edge 344 extends from a bottom of the blade section upwardly and rearwardly toward the mounting section 338.

When installed within the guard 304, the razor blade 302 (and sharpened edge 344) is only partially exposed in any direction beyond the guard 304, which protects the sharpened edge 344 from inadvertent contact. The mounting section 338 extends along and is fastened to the seat 318. By securing the mounting section 338 of the razor blade 302 to the seat 318, the blade portion 340 extends downwardly, into the blade segment 316 of the cavity 312. A portion of the sharpened edge 344 protrudes outwardly, beyond the two converging sections 308, 310, to the arm 320. The distal end of the sharpened edge 344 can engage a wall of the recess 332. The shape of the sharpened edge 344 and razor blade 302 shown and described is such that when the razor blade 302 is installed within the guard 304, the sharpened edge 344 extends obliquely relative to the front wall 124 of the main body 112, and transversely across the channel 306. The sharpened edge 344 tapers downwardly as it extends outward from the converging sections 308, 310 to the arm 320, which provides an easier fishing line cutting motion and process by promoting at least some degree of lateral, slicing movement across the sharpened edge 344.

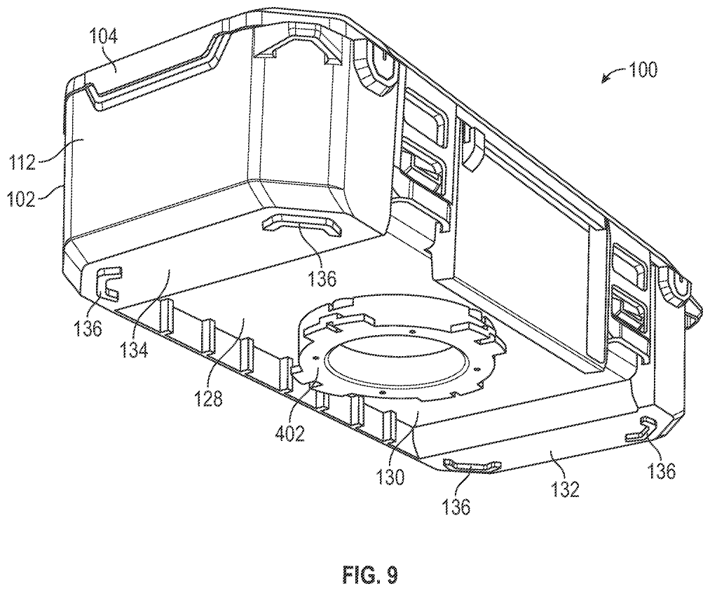

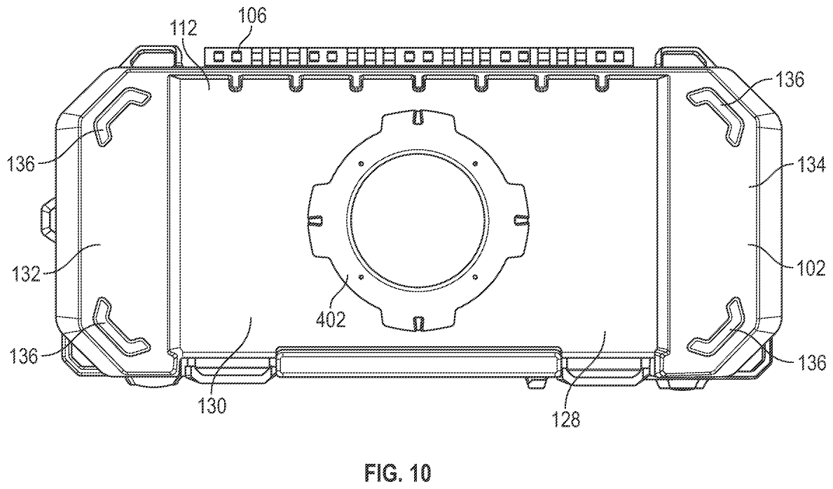

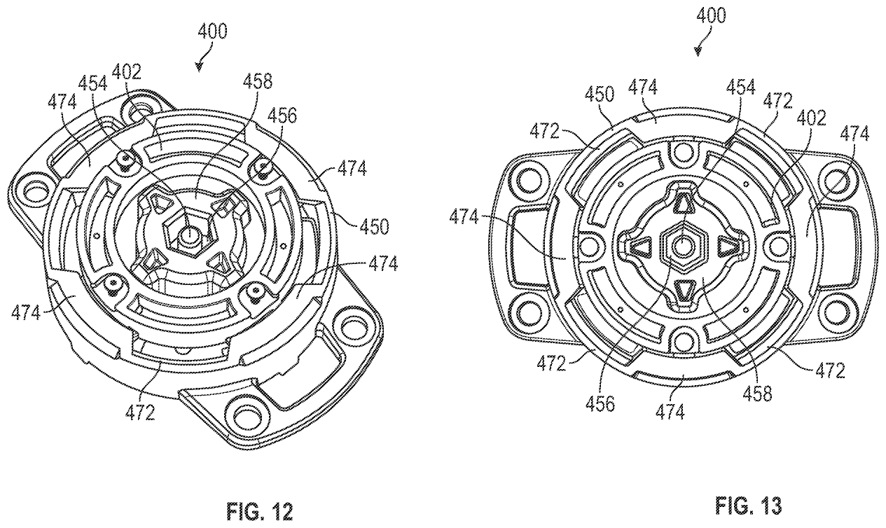

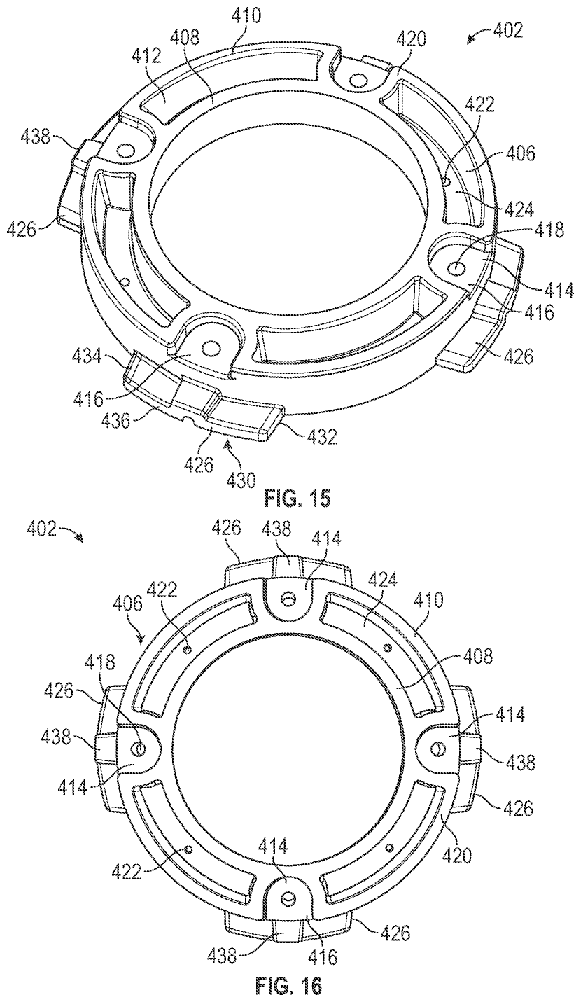

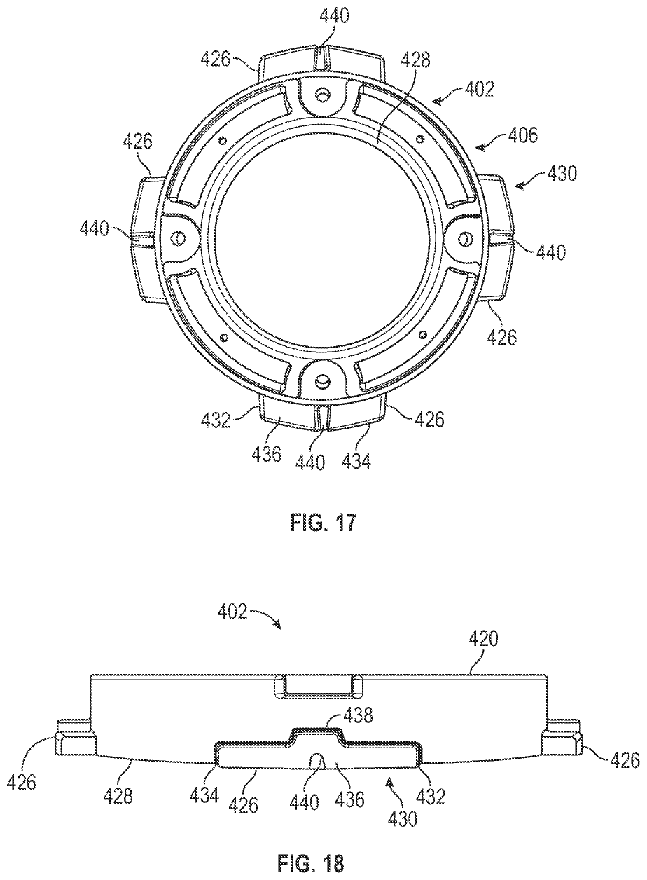

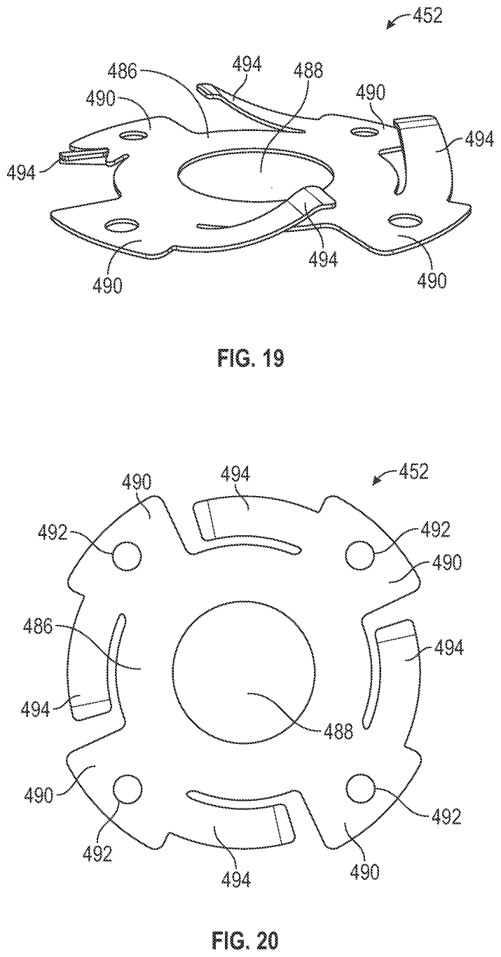

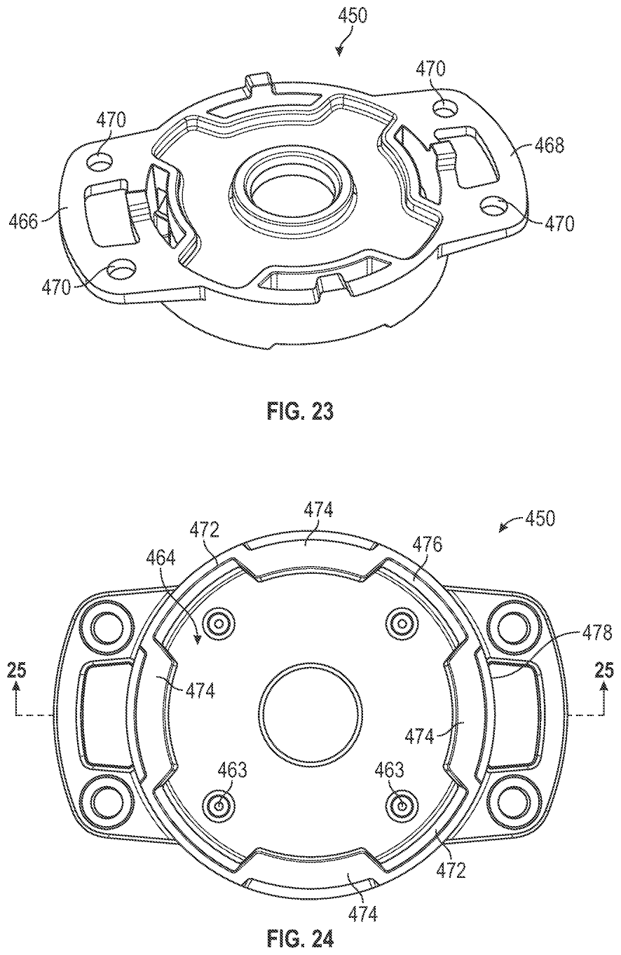

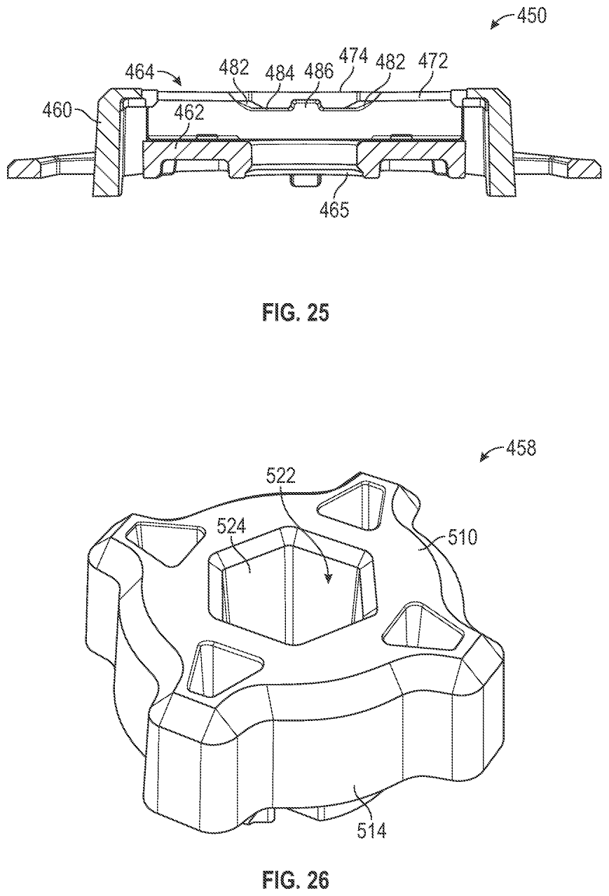

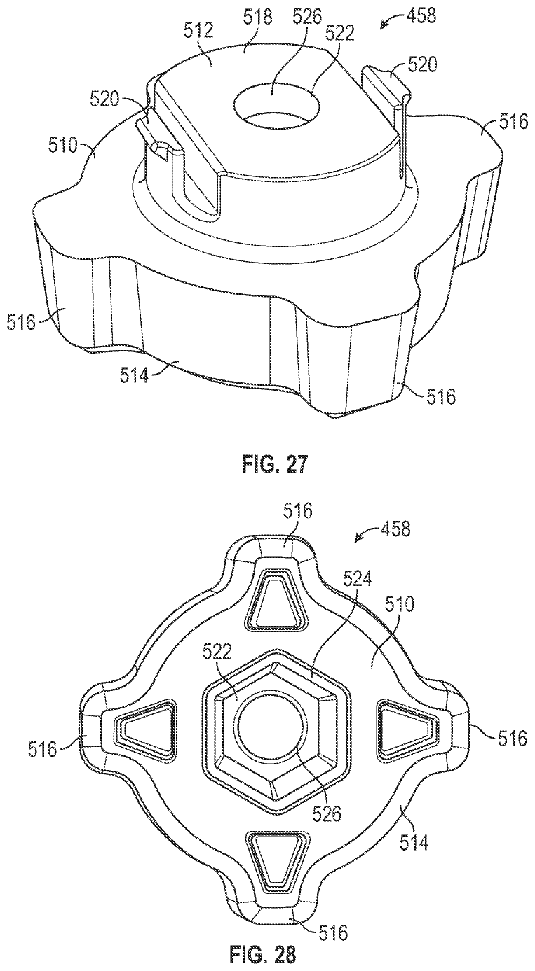

Referring now to FIGS. 9-30, a fishing storage box mounting assembly 400 is depicted. The fishing storage box mounting assembly 400 generally includes a rail mount 402 and an adapter assembly 404 that can receive and selectively secure the rail mount 402. The mounting assembly 400 allows the fishing storage box 100 to be quickly and removably secured to various locations on a boat or other surface incorporating a track rail system (shown in FIG. 30.)

Focusing on FIGS. 9-10 and 15-18, the rail mount 402 of the mounting assembly 400 is shown in further detail. The rail mount 402 is formed continuously with or otherwise coupled (e.g., fastened) to a bottom surface 128 of the main body 112. The rail mount 402 extends away from a recessed portion 130 of the bottom surface 128 that is offset from and straddled by two legs 132, 134 formed on either end of the main body 112. Anti-sliding pads 136 are positioned at each corner of the main body 112 (on the legs 132, 134) to help prevent unwanted movement of the fishing storage box 100 relative to a surface and to further elevate the fishing storage box 100 such that a lowermost surface 428 of the ring mount 402 is offset upward from at least a portion of the legs 132, 134. Accordingly, when the fishing storage box 100 is set on a flat surface (e.g., without any adapter assembly 404), the fishing storage box 100 rests on the legs 132, 134 (specifically, the anti-sliding pads 136 of the legs 132, 134) rather than on the rail mount 402, which could otherwise impact the stability of the fishing storage box 100.

The rail mount 402 is defined by a generally annular body 406. The annular body 406 includes two rings 408, 410 spaced apart from one another to define a discontinuous channel 412. Discontinuities in the channel 412 are created by mounting pads 414 that extend from the inner ring 408 to the outer ring 410 of the annular body 406. The mounting pads 414 include a recessed seat 416 and a mounting hole 418 extending at least partially through the mounting pad 414 and into the annular body 406. The mounting holes 418 are threaded so to receive and support a fastener (not shown) that can extend through the bottom surface 128 of the main body 112 and into the rail mount 402 to secure the rail mount 402 to the bottom of the fishing storage box 100. When coupled to the bottom surface 128 of the main body 112, the uppermost surface 420 engages the bottom surface 128. Weep holes 422 formed within a base 424 of the channel 412 can provide drainage for any liquids (e.g., water) that might otherwise become trapped within the channel 412.

Dovetails 426 extend radially outward away from the annular body 406. The dovetails 426 extend away from a bottom (e.g., a lowermost surface 428) of the annular body 406, and are each defined by a dovetail body 430 of their own. The dovetail body 430 includes side walls 432, 434 extending outwardly away from the outer ring 410 of the annular body 406. The side walls 432, 434 each extend approximately parallel to one another (e.g., within about 10 degrees). A curved wall 436 extends between each of the side walls to define the perimeter of the dovetail 426. The curved wall 436 can be defined by a radius that is approximately concentric with the inner ring 408 and outer ring 410 of the annular body 406. In some examples, a protrusion 438 extends upwardly from the dovetail body 430. As explained below, the protrusion 438 can help position and secure the ring mount 402 relative to the adapter assembly 404. Likewise, a notch 440 can be formed within an underside of the dovetail body 430, opposite the protrusion 438.

The number and position of the dovetails 426 partially determines the possible “locked” orientations of the fishing storage box 100, as explained in additional detail below. As depicted in FIGS. 9-10 and 15-17, four dovetails 426 extend radially outward from the annular body 406. The dovetails 426 are evenly spaced about the annular body 406 so that each dovetail 426 is centered approximately 90 degrees offset from a center of each adjacent dovetail 426. Accordingly, each of the protrusions 438 and notches 440 can be offset by about 90 degrees from each adjacent protrusion 438 and notch 440.

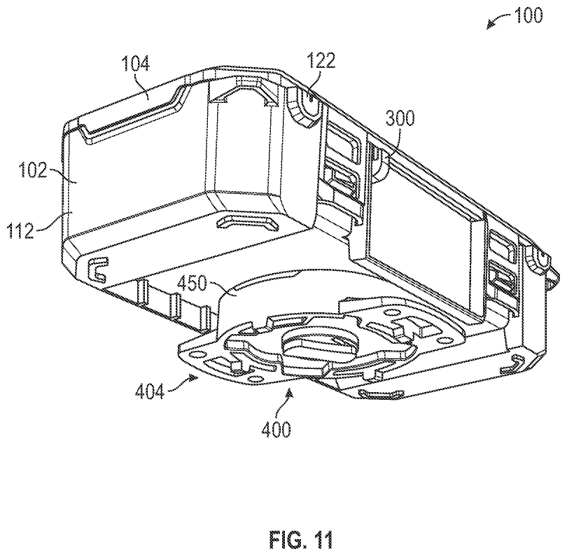

With additional reference now to FIGS. 11-13, the adapter assembly 404 and, more specifically, the coupling formed between the adapter assembly 404 and the ring mount 402 is shown. The adapter assembly 404 selectively receives the ring mount 402, which in turn secures the fishing storage box 100 to the adapter assembly 404. The interaction between the ring mount 402 and adapter assembly 404 is readily understood by examining the individual components of the adapter assembly 404 and the adapter assembly, in isolation.

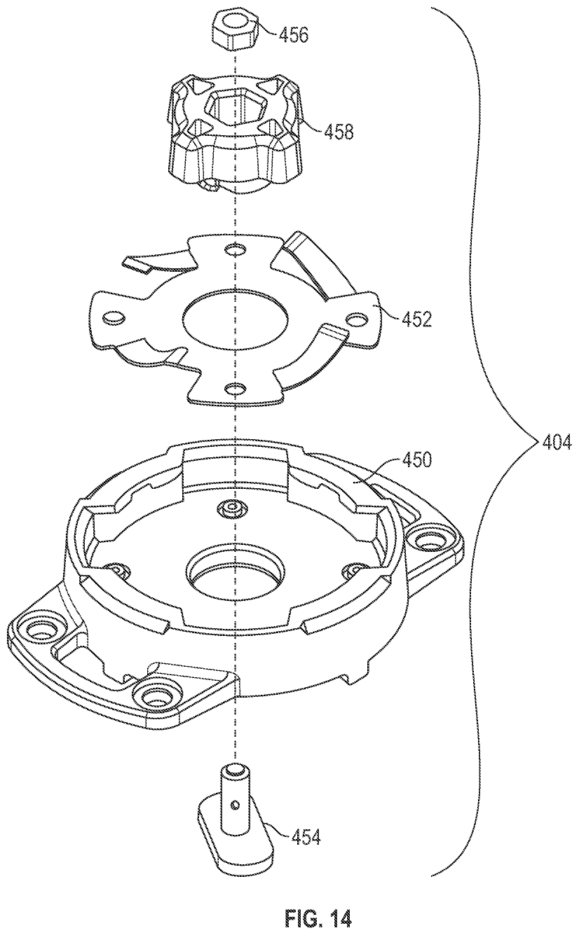

Referring first to FIG. 14, the adapter assembly 404 is depicted. The adapter assembly 404 includes an adapter body 450 that receives a wave spring 452. The adapter body 450 and wave spring 452 together engage and secure the rail mount 402 within the adapter assembly 404. A T-bar 454 working in conjunction with a nut 456 and collar 458 is used to secure the adapter assembly 404 in a desired location along a track rail (e.g., track rail 600, in FIG. 30.)

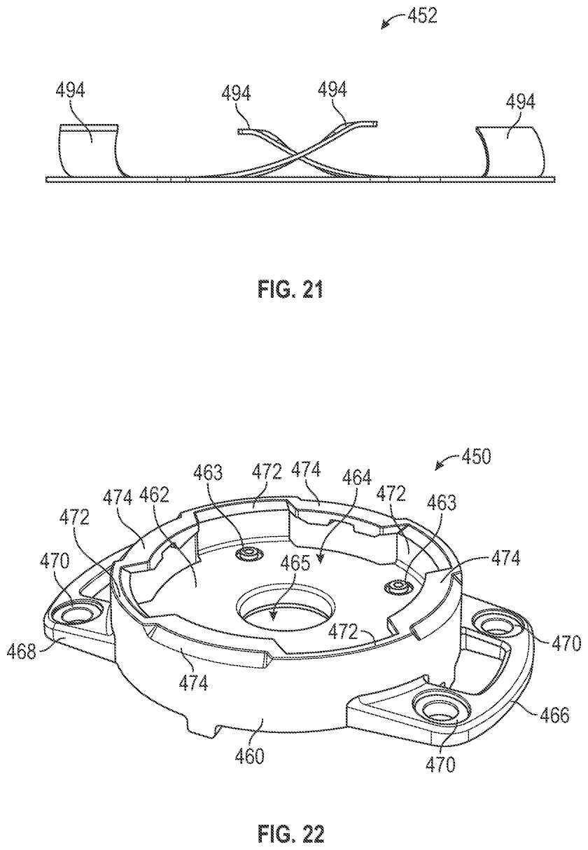

With additional reference to FIGS. 22-25, the adapter body 450 is shown in detail. The adapter body 450 is partially defined by a cylindrical wall 460 that extends away from a base 462. The cylindrical wall 460 and base 462 collectively define and surround a cavity 464 that can receive, among other things, the wave spring 452 and the rail mount 402. In some examples, spring bosses 463 extend upwardly from the base to interact with and restrain relative motion between the wave spring 452 and the adapter body 450. A central bore 465 is formed through the base 462. Mounting wings 466, 468 extend outwardly away from opposite sides of the cylindrical wall 460 and include holes 470 formed through the mounting wings 466, 468. Mounting wings 466, 468 can be used to anchor the adapter body 450 into place on a surface (e.g., a wall of a boat) when no track rail is present.

The cylindrical wall 460 includes a series of alternating flutes 472 and lips 474 that together interact with the rail mount 402 to produce a releasable coupling. Four flutes 472 are formed within an inner surface of the cylindrical wall 460 to provide additional clearance for the ring mount 402. The flutes 472 are evenly spaced apart from one another and are at least partially defined by an arc 476 that is larger than the curved wall 436 of the dovetails 426. Accordingly, the flutes 472 are sized so that the ring mount 402 can be pushed into the adapter body 450 when the dovetails 426 are aligned with and/or partially received within one or more of the flutes 472.

The lips 474 formed at a top of the cylindrical wall 460 help secure the ring mount 402 within the adapter body 450. The lips 474 extend radially inward from the cylindrical wall 460 so that the lips 474 overhang at least a portion of the base 462. As depicted in FIG. 24, each lip 474 is offset from each flute 472, and each lip 474 extends entirely between each adjacent flute 472. The lips 474 are defined, generally, by a widened base 478 that tapers as the lip 474 extends radially inward from the cylindrical wall 460 to an inner edge 480 having an arc length smaller than an arc length defining the base 478. The lips 474 are further defined by ramped guiding sections 482 that taper downwardly toward a flat locking section 484 having a thicker cross-section than the guiding sections 482. A recess 486 is formed within a center of the locking section 484 and is sized to receive the protrusion 438 formed in each dovetail 426.

Referring to FIGS. 14 and 19-21, the wave spring 452 is received within the cavity 464, and rests on the base 462 of the adapter body 450. The wave spring has a flat, ring-shaped body 486 extending around a central bore 488 with flanges 490 that extend outwardly away from the central bore 488 and body 486. The flanges 490 each define a mounting hole 492 that can be used to help position and/or secure the wave spring 452 within the cavity 464 of the adapter body 450. For example, the mounting holes 492 can be sized to receive the spring bosses 463 formed within the adapter body 450. The spring bosses 463 engage the mounting holes 492 and restrict relative rotational motion between the wave spring 452 and adapter body 450. A cantilevered arm 494 extends axially and angularly away from one end of each flange 490 toward an adjacent flange 490. Accordingly, the cantilevered arms 494 each wrap helically around a portion of the body 486 as they extend upwardly away from the flanges 490. The cantilevered nature of the arms 494 provides a natural, spring-like bias that opposes downward motion, toward the body 486. When positioned within the cavity 464 of the adapter body 450, the cantilevered arms 494 collectively oppose downward motion toward the base 462 of the adapter body. The spring force produced by the cantilevered arms 494 can also move the ring mount 402 upward, into engagement with the lips 474 formed within the adapter body 450, as explained below.

While the adapter body 450 and wave spring 452 help secure the ring mount 402 to the adapter assembly 404, the T-bar 454, nut 456, and collar 458 together form a mounting system that secures the adapter assembly 404 in place along a track rail 600, shown in FIG. 30. The collar 458 and nut 456 can be rotated relative to the T-bar 454 to increase or decrease a clamping force between the collar 458 and the T-bar 454, which can be sufficient to secure the mounting system and adapter assembly 404 in place along the track rail 600.

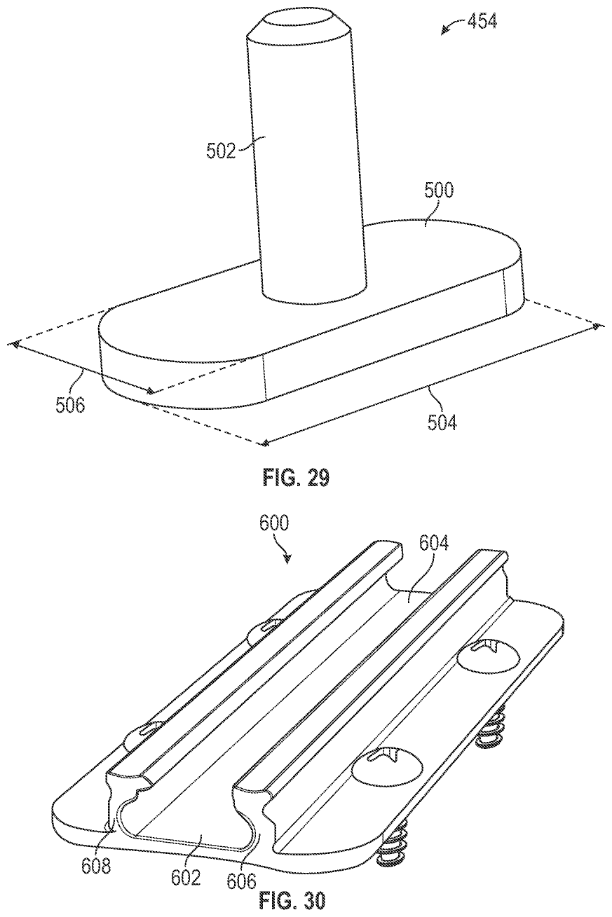

The T-bar 454, depicted in FIG. 29, includes a flange 500 and a threaded stem 502 extending upwardly away from the flange 500. The flange 500, as described in more detail below, is defined by an elongate, oval shape that is designed to be removably received within a channel 602 formed with the track rail 600. The flange 500 is defined by a width (measured along axis 504) that is greater than a width defining the channel 602 formed within the track rail 600. The flange 500 is also defined by a length (measured along axis 506) that is smaller than the distance between the two opposing segments 606, 608 at a neck 604 of the track rail 600, so that when oriented properly, the T-bar flange 500 can be removed or inserted into the channel 602 of the track rail 600. Once rotated slightly within the channel 602, the flange 500 of the T-bar 454 spans entirely across the neck 604, and interference between the opposing segments 606, 608 and the flange 500 opposes T-bar 454 removal.

The nut 456 and collar 458 work together with the T-bar 454 to clamp the T-bar 454 against the opposing segments 606, 608 within the channel 602, which secures the T-bar 454 and adapter assembly 404, more generally, in a desired location along the track rail 600. With reference now to FIGS. 14 and 26-30, the collar 458 is shown in isolation. The collar 458 is formed as a continuous piece with an upper section 510 and a lower section 512 extending away from the upper section 510. The upper section 510 is defined by a generally cylindrical outer wall 514 having protrusions 516 extending radially outward at evenly spaced intervals (e.g., every 90 degrees). The protrusions 516 can provide grip for a user trying to rotate the collar 458 to further engage or disengage the T-bar 454. The lower section 512 is defined by a generally cylindrical boss 518. The generally cylindrical boss 518 is straddled by two cantilevered hooks 520 that can be used to engage an underside of the adapter body 450. The upper section 510 and lower section 512 collectively define a counterbore 522 extending entirely through the collar 458. The counterbore 522 includes a hexagonal section 524 formed within the upper section 510 and a cylindrical section 526 formed within the lower section 512 of the collar 458. The nut 456, which can be hex nut, is received within the hexagonal section 524 of the counterbore 522. In some examples, the nut 456 is adhesively coupled to the collar 458 so that the relative position between the collar 458 and nut 456 remains constant. By placing the nut 456 within the hexagonal section 524 of the counterbore 522, the nut 456 rotates in concert with the collar. Accordingly, any rotational motion imparted on the collar 458 rotates the nut 456 into or out of further engagement with the threaded stem 502 of the T-bar 454.

With the components of the fishing storage box mounting assembly 400 described, the operation and interaction of components, as well as a method for mounting the fishing storage box 100 using the fishing storage box mounting assembly 400 can be more readily understood. With reference now to FIGS. 9-30, the adapter assembly 404 and ring mount 402 are initially decoupled from one another, such that the fishing storage box 100 and adapter assembly 404 are freely movable relative to one another. The adapter assembly 404 is unclamped from the track rail 600, and freely movable along a length of the track rail 600, shown in FIG. 30. The track rail 600, shown in FIG. 30, extends along a surface or wall of a boat (not shown).

First, the adapter assembly 404 can be positioned in a desired location along the track rail 600. The adapter body 450, which supports each of the wave spring 452, T-bar 454, nut 456, and collar 458, can be slid along an outer surface of the track rail 600. The flange 500 of the T-bar 454, shown in FIG. 29, extends downward through the central bore 465 of the adapter body 450 and is received within the channel 602 of the track rail 600. The nut 456 and collar 458 are positioned within the cavity 464 of the adapter body 450, opposite the flange 500 of the T-bar 454. The nut 456 is threaded onto the threaded stem 502 of the T-bar 454, but is not tightened sufficiently to produce a clamping force between the flange 500 and the collar 458 (or adapter body 450) that can maintain the adapter assembly 404 in a stationary position along the track rail 600. Because the flange 500 of the T-bar 454 is slightly rotated within the channel 602 of the track rail 600, the T-bar 454 and adapter body 450 can slide along the length of the track rail 600 to any desired location along the track rail 600. The T-bar 454, nut 456, and collar 458 are each aligned with and/or at least partially received within the central bore 465 of the adapter body 450.

When a desired location along the track rail 600 is reached by the T-bar 454 and the adapter body 450, the collar 458 and nut 456 can be rotated to advance the threads of the nut 456 onto the threaded stem 502 of the T-bar 454. Rotation of the collar 458 rotates the nut 456 into further engagement with the threaded stem 502 of the T-bar 454. As the nut 456 travels toward the flange 500 of the T-bar 454, the T-bar 454 may initially resist or otherwise attempt to rotate with the nut 456, rather than allow the threads of the nut 456 to advance downward on the stem 502 toward the flange 500. While some initial rotation of the T-bar 454 may occur, the width of the flange 500 (which is larger than the width of the channel 602) restricts the degree of permissible rotation of the T-bar 454 when the flange 500 is positioned within the channel 602 of the T-bar. Accordingly, the T-bar 454 will only be able to rotate within the channel 602 until the flange 500 engages each of the opposing segments 606, 608 of the track rail 600. Once engaged with the opposing segments 606, 608 of the track rail 600, the flange 500 and T-bar 454 cannot further rotate in the direction that the nut 456 is being rotated, so further rotation of the collar 458 causes the nut 456 to advance downward on the threads of the threaded stem 502 of the T-bar 454. The collar 458 can be rotated until an upper surface of the flange 500 engages each of the opposing segments 606, 608 of the track rail 600. The nut 456 and flange 500 together create a clamping force around the opposing segments 606, 608 of the track rail 600 that opposes sliding movement of the adapter assembly 404 along the track trail 600. The nut 456 and collar 458 move the base 462 of the adapter body 450 downward, into engagement with the track rail 600, so that friction between the T-bar 454, adapter body 450, and the opposing segments 606, 608 of the track rail 600 restrict movement between the components.

With T-bar 454, nut 456, and collar 458 securing the adapter body 450 and adapter assembly 404 in position along the track rail 600, the ring mount 402 and fishing storage box 100 can be coupled to the adapter assembly 404. Initially, the fishing storage box 100, which includes the ring mount 402, should be aligned with the adapter body 450. Specifically, the ring mount 402 should be positioned so that each dovetail 426 of the ring mount 402 is approximately aligned with and positioned above each of the flutes 472 formed within the adapter body 450.

With the dovetails 426 of the ring mount 402 aligned with the flutes 472 of the adapter body 450, the ring mount 402 can be moved downward, into the cavity 464 of the adapter body 450. The bias of the cantilevered arms 494 of the wave spring 452 opposes but does not prevent the downward movement of the ring mount 402 into the cavity 464 of the adapter body 450. The fishing storage box 100 can be moved further downward toward the base 462 of the adapter body 450, until each of the dovetails 426 are positioned axially below the lips 474 of the adapter body 450.

With the dovetails 426 positioned axially below the lips 474 of the adapter body 450, the fishing storage box 100 and ring mount 402 can then be rotated to lock the fishing storage box 100 within the adapter assembly 404. In the configuration depicted with four dovetails 426 and four lips 474, rotating the fishing storage box 100 and ring mount 402 by 45 degrees will rotate the dovetails 426 into angular alignment with the lips 474. To lock the fishing storage box 100 within the adapter assembly 404, the ring mount 402 is rotated until the protrusions 438 of each dovetail 426 are aligned with the recesses 486 of each lip 474 on the adapter body 450.

Once proper alignment between the ring mount 402 and the adapter body 450 has occurred, the downward force on the fishing storage box 100 can be released, allowing the fishing storage box mounting assembly 400 to achieve the “locked” configuration shown in FIGS. 11-13. The bias of the cantilevered arms 492 of the wave spring 452 pushes the ring mount 402 and fishing storage box 100 upward, away from the base 462 of the adapter body 450. The upward spring force of the wave spring 452 pushes the protrusions 438 of the dovetails 426 on the ring mount 450 into the recesses 486 of the lips 474 on the adapter body 450. Further upward movement of the ring mount 402 relative to the adapter body 450 and adapter assembly 404 is prevented by the overlap between the dovetails 426 and the lips 474. Rotational movement between the ring mount 402 and the adapter body 450 and adapter assembly is prevented by the engagement between the protrusions 438 of the dovetails 426 and the recesses 486 of the lips 474. Accordingly, the fishing storage box 100 can be considered “locked” into position on the adapter assembly 404, as depicted in FIG. 11.

A similar procedure can be used to unlock and remove the fishing storage box 100 from the adapter assembly 404. First, a downward force should be applied to the fishing storage box 100. If the downward force is sufficient to overcome the upward bias of the cantilevered arms 494 of the wave spring 452, the ring mount 402 will move downward, toward the base 462 of the adapter body 450. The downward movement of the ring mount 402 disengages the protrusions 438 of the dovetails 426 from the recesses 486 within the lips 474 of the adapter body 450.

With the protrusions 438 disengaged from and axially offset from the recesses 486, the ring mount 402 can be rotated relative to the adapter body 450 and adapter assembly 404. Rotation of the fishing storage box 100 in either direction (i.e., clockwise or counterclockwise) can be used to remove the fishing storage box 100 from the adapter assembly 404. Specifically, the fishing storage box 100 and ring mount 402 should be rotated about 45 degrees so that the dovetails 426 of the ring mount 402 are once again aligned with or received within the flutes 472 of the adapter body 450. Once the dovetails 426 are positioned within the flutes 472 and are not overlapped by any of the lips 474 of the adapter body 450, relative axial movement between the ring mount 402 and the adapter body 450 can occur. Upward lifting force, in combination with the upward spring force from the wave spring 452, can then be used to remove the ring mount 402 and fishing storage box 100 outward and away from the adapter assembly 404.

Using the fishing storage box mounting assembly 400, the fishing storage box 100 can be mounted in at least four distinct orientations (e.g., 0 degrees, 90 degrees, 180 degrees, 270 degrees) relative to the adapter assembly 404. Accordingly, a fisherman or fisherwoman can select the orientation that is most convenient at any given time, which may change depending on the position, type, or size of boat or vessel that the fishing storage box 100 is being used on. By having the lips 474 evenly spaced about the adapter body 450 and the dovetails 426 evenly spaced about the ring mount 402, the same magnitude of rotation of the ring mount 402 relative to the adapter body in either direction is sufficient to lock or unlock the ring mount 402 from the adapter assembly 404. Additionally, a fisherman or fisherwoman can readily adjust the orientation by rotating the fishing storage box 100 by twice the magnitude necessary to unlock the ring mount 402 from the adapter assembly 404. As shown, 45 degree rotation (or 135 degree, 225 degree, or 315 degree rotation) will rotate the dovetails 426 from a position below the lips 474 to a position aligned with the flutes 472. 90 degree rotation (or 180 degree or 270 degree rotation) will rotate the dovetails 426 into a second position below the lips 474, where the fishing storage box 100 can once again be locked onto the adapter assembly 404. While the above-described fishing storage box mounting assembly 400 has been described using a ring mount 402 and adapter body 450 having four dovetails 426 and four lips 474, different orientations can be employed as well. Increasing the number of dovetails 426 and/or lips 474 can increase the number of potential locked orientations of the fishing storage box 100 relative to the track rail 600, while decreasing the number of dovetails 426 and/or lips 474 will decrease the number of potential locked orientations of the fishing storage box 100 relative to the track rail 600. The number and spacing of dovetails 426 and lips 474 can be selected to accommodate the needs of each fisherman or fisherwoman individually.

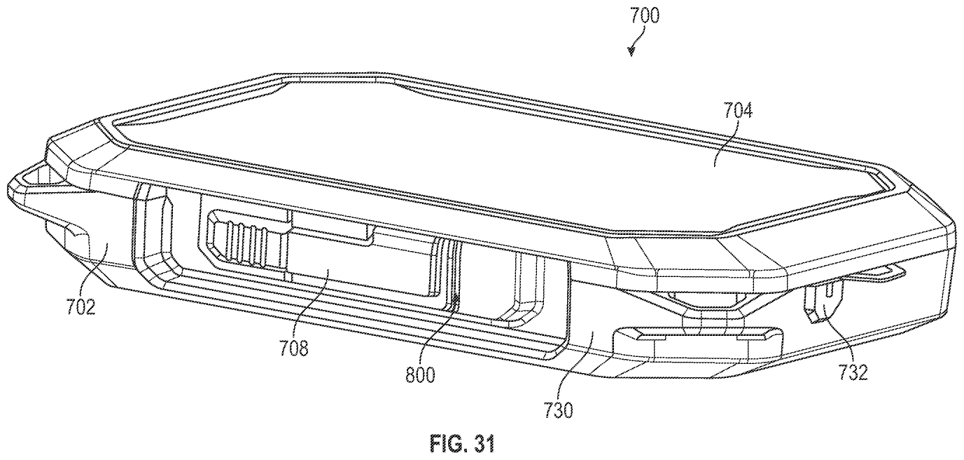

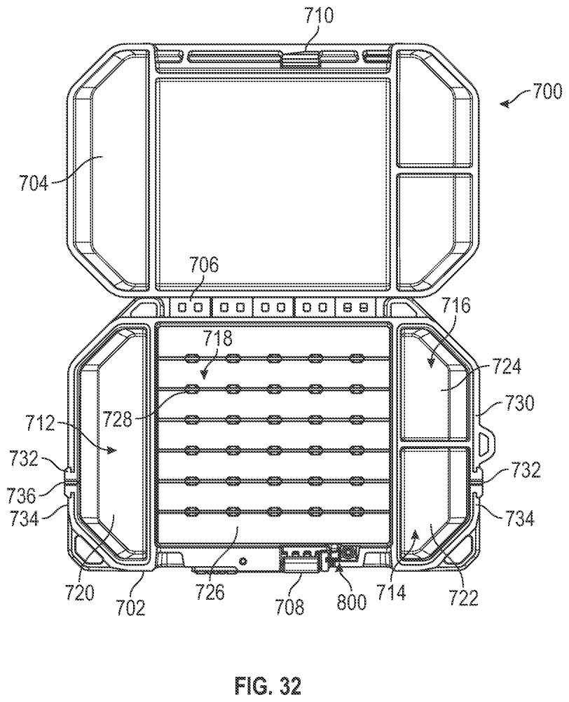

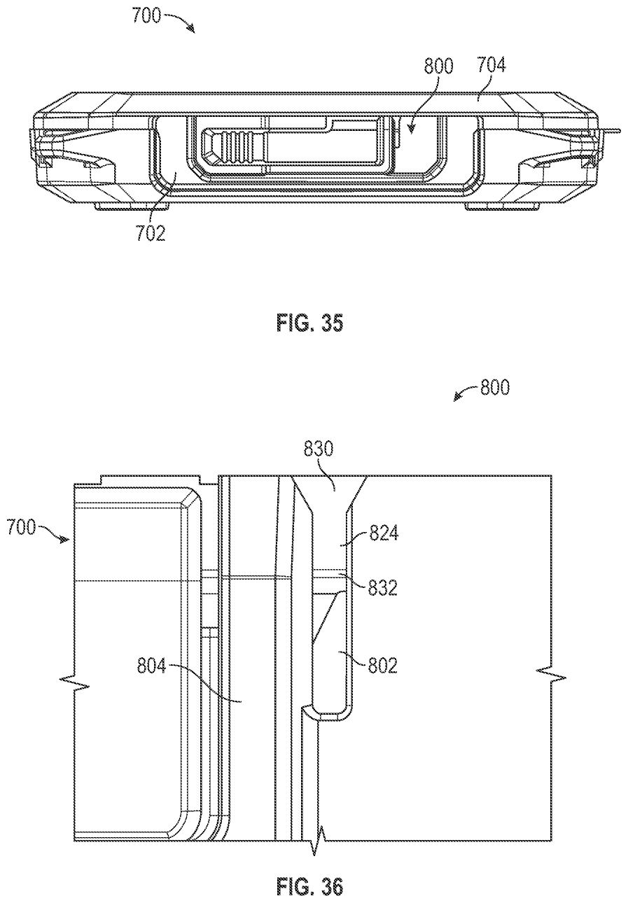

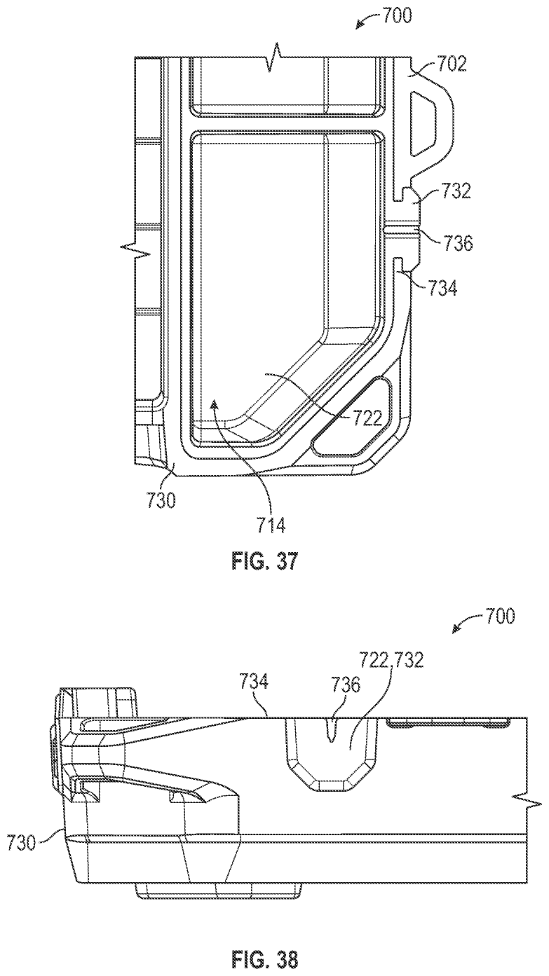

With reference now to FIGS. 31-38, another fishing storage box 700 is provided. The fishing storage box 700, like the fishing storage box 100, generally includes a container 702 and a cover 704 that is pivotally coupled to the container 702. The cover 704 can rotate between a closed position (shown in FIG. 31) and an open position (shown in FIG. 32) about a hinge joint 706 formed between the container 702 and the cover 704. The fishing storage box 700, which can be sized to fit in the pocket of a fisherman or fisherwoman, can be secured in the closed position using a singular latch 708 and catch 710 formed at the front of the fishing storage box 700.

The container 702 of the fishing storage box 700 is also designed to receive and store a variety of tools and fishing tackle that may be useful while fishing. As detailed by FIG. 32, the container defines a number of compartments 712, 714, 716, 718 that can be used to house materials. Each of the compartments 712, 714, 716, 718 receive elastomeric inserts 720, 722, 724, 726 of varying sizes to safely store and secure items. The elastomeric inserts 720, 722, 724, 726 can be secured within each of the compartments 712, 714, 716, 718 using an adhesive. The elastomeric inserts 720, 722, 724, 726 can include cup-like receptacles 720, 722, 724 as well as strips of material 726 defining an array of recesses 728. The receptacles 720, 722, 724 can receive and store larger lures, tools, and/or fishing line, while the recesses 728 formed within the strips of material 726 are adapted to receive smaller lures, like flies. Lures and other sharp items (e.g., hooks) can be pierced into the elastomeric inserts 720, 722, 724, 726 to secure the items into place within the fishing storage box 700. The elastomeric inserts 720, 722, 724, 726 further provide noise dampening to hard objects received within the fishing storage box 700.

As depicted in FIGS. 32 and 37-38, elastomeric inserts 720, 722 can each include a line cleat 732. The line cleat 732 is formed continuously with the inserts 720, 722 and extends outwardly away from each receptacle to hold and secure fishing line. The line cleats 732 are each received within walls 734 formed within the main body 730 of the container 702, which compress the line cleats 732 together so that fishing line can be securely received within the slits 736 of each line cleat 732. Forming the line cleats 732 continuously within the elastomeric inserts 720, 722 can reduce manufacturing complexity and assembly time.

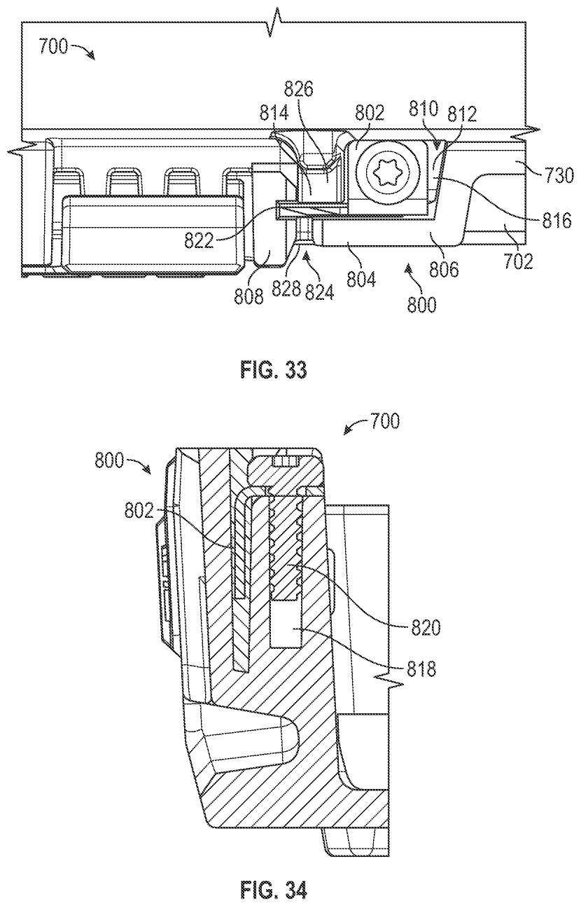

The fishing storage box 700, like the fishing storage box 100, also includes an integrated line cutter assembly 800. As depicted in FIGS. 33-37, the line cutter assembly 800 generally includes a razor blade 802 and a guard 804 at least partially surrounding and selectively permitting access to the razor blade 802 based upon size. The guard 804 is again partially defined by two converging sections 806, 808 that are formed within a top section of a main body 730 of the container 702. Like the line cutter assembly 300, the line cutter assembly 800 is once again formed at or adjacent to the front of the container 702.

The converging sections 806, 808 define a blade cavity 810 formed inward from the main body 730 of the container 702. The blade cavity 810 includes a widened mounting section 812 and a narrowed blade section 814 extending away from the mounting section 812. The mounting section 812 is further defined by a mounting seat 816 that further includes a blind hole 818 extending downward from the mounting seat 816 to receive a mounting screw 820. The blade section 814 of the blade cavity 810 extends away from the mounting section 812 and first converging section 806 toward and into the second converging section 808 of the main body 730. A groove 822 formed within the second converging section 808 can receive the distal, sharpened edge of the razor blade 802. Accordingly, the walls defining the groove 822 provide additional protection from an object accidentally coming into contact with the razor blade 802.

A channel 824 is formed between the converging sections 806, 808 and through the main body 730 to define a line passageway within the fishing storage box 700. The channel 824 is defined by a variable width, and is designed to direct fishing line extending within the line passageway toward the sharpened edge of the razor blade 802 to cut the fishing line. As depicted in FIG. 33, the internally-accessible section 826 of the channel 824 can be defined by a width that is greater than the externally-accessible section 828 of the channel 824. A top of the channel 824 can be defined by a widened mouth 830 that tapers downward and inward to direct fishing line into the guide section 832 and into contact with the blade 802, as shown in FIG. 36. By positioning the razor blade within the main body 730, the line cutter assembly 800 is generally inaccessible when the cover 804 is in the closed position. In both the open and closed positions, however, the channel 824 is narrow enough that larger external objects (e.g., a finger of a user) are restricted from coming into accidental contact with the razor blade 802. When the cover 704 is open, smaller objects (e.g., fishing line) are permitted to pass into the channel 824 and into contact with the razor blade 802 to execute a cutting operation. The razor blade 802 is shaped and designed to be similar to the razor blade 302 described above, the disclosure and description of which is incorporated herein by reference in its entirety. The razor blade 802 is positioned within the main body 730 of the container 702 so as to extend approximately parallel with a front of the fishing storage box 700.

No claim element herein is to be construed under the provisions of 35 U.S.C. § 112(f), unless the element is expressly recited using the phrase “means for.”

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above.

It is important to note that the construction and arrangement of the fishing storage box as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A storage box comprising:
a container having a main body defining a cavity;
a cover hingedly coupled to the container to allow selective access to the cavity;
a rail mount extending away from a bottom surface of the main body, the rail mount being defined by an annular body having at least one dovetail extending radially outward therefrom, the at least one dovetail movable relative to an adapter assembly to mount the fishing storage box in at least two indexed positions.

2. The storage box of claim 1, wherein four dovetails extend radially outward from the annular body, each of the four dovetails being approximately evenly spaced from each adjacent dovetail.

3. The storage box of claim 1, wherein the at least one dovetail extends radially outward from a lowermost surface of the annular body.

4. The storage box of claim 1, wherein the bottom surface of the main body is at least partially defined by legs and a recessed surface offset from the legs and extending between the legs, the legs being formed on opposite ends of the main body, and wherein the rail mount is coupled to recessed surface.

5. The storage box of claim 4, wherein a lowermost surface of the annular body is offset upward from at least a portion of the legs.

6. The storage box of claim 1, wherein the rail mount is fastened to the bottom surface of the main body.

7. The storage box of claim 1, wherein the adapter assembly comprises:
an adapter body partially defined by a cylindrical wall circumscribing a body cavity, wherein at least one flute is formed within an inner surface of the cylindrical wall, and wherein a lip extends radially inward from the cylindrical wall, angularly offset from the at least one flute; and
a wave spring received within the body cavity and including cantilevered arms providing an upward bias, away from a base of the adapter body toward the lip;
wherein the rail mount is releasably coupled to the adapter assembly by aligning the at least one dovetail with the at least one flute, moving the rail mount downward, against the upward bias of the wave spring until the at least one dovetail is positioned axially below the lip, and rotating the rail mount to a position where at least a portion of the lip overlaps a portion of the at least one flute.

8. The storage box of claim 7, wherein four flutes are formed within the inner surface of the cylindrical wall, four lips extend radially inward from the cylindrical wall, and four dovetails extend radially outward from the annular body of the rail mount.

9. The storage box of claim 7, further comprising:
a T-bar having a flange and a threaded stem extending away from the flange, upwardly through a bore formed in the base of the adapter body into the body cavity; and
a nut threadably received on the stem and rotatable to reduce a distance between the nut and the flange to create a clamping force.

10. The storage box of claim 9, further comprising:
a collar, the collar having an upper section and a lower section extending away from the upper section, the upper section and lower section collectively defining a counterbore therethrough, the counterbore being defined by a hexagonal section and a cylindrical section;
wherein the nut is received within the hexagonal section of the counterbore and configured to rotate in concert with the collar.

11. The storage box of claim 10, wherein the lower section is defined by a generally cylindrical boss straddled by two cantilevered hooks, the cylindrical boss and hooks extending through the bore formed in the base of the adapter body so that a portion of the hooks engage a bottom surface of the base of the adapter body to couple the collar to the adapter body.

12. The storage box of claim 1, wherein the storage box further comprises an organizational cup removably received within the cavity, the organizational cup being defined by an outer wall surrounding a receptacle and further including a line wrap extending laterally away from the outer wall.

13. The storage box of claim 1, wherein a line cutter assembly is at least partially formed within the main body, the line cutter assembly including a razor blade removably received within a guard.

14. The storage box of claim 1, wherein the storage box further comprises an organizational cup removably received within the cavity, the organizational cup being defined by an outer wall surrounding a receptacle and further including a line wrap extending laterally away from the outer wall, and wherein a line cutter assembly extends away from the main body, the line cutter assembly including a razor blade removably received within a guard.

15. An adapter assembly for mounting an item to a track rail, the adapter assembly comprising:
A rail mount being defined by an annular body having at least one dovetail extending radially outward therefrom;
an adapter body partially defined by a cylindrical wall circumscribing a body cavity, wherein at least one flute is formed within an inner surface of the cylindrical wall, and wherein a lip extends radially inward from the cylindrical wall, angularly offset from the at least one flute; and
a wave spring received within the body cavity and including cantilevered arms providing a bias away from a base of the adapter body toward the lip;
wherein the rail mount is releasably coupled to the adapter body by aligning the at least one dovetail with the at least one flute, moving the rail mount toward the base of the adapter body against the bias of the wave spring until the at least one dovetail is positioned between the base of the adapter body and the lip, and rotating the rail mount to a position where at least a portion of the lip overlaps the at least one flute.

16. The adapter assembly of claim 15, wherein four flutes are formed within the inner surface of the cylindrical wall, four lips extend radially inward from the cylindrical wall, and four dovetails extend radially outward from the annular body of the rail mount.

17. The adapter assembly of claim 15, further comprising:
a T-bar having a flange and a threaded stem extending away from the flange, upwardly through a bore formed in the base of the adapter body into the body cavity; and
a nut threadably received on the stem and rotatable to reduce a distance between the nut and the flange to create a clamping force between the T-bar and the nut sufficient to restrict movement of the adapter body relative to the track rail.

18. The adapter assembly of claim 17, further comprising:
a collar, the collar having an upper section and a lower section extending away from the upper section, the upper section and lower section collectively defining a counterbore therethrough, the counterbore being defined by a hexagonal section and a cylindrical section;
wherein the nut is received within the hexagonal section of the counterbore and configured to rotate in concert with the collar.

19. A method of mounting a storage box on a track rail, the method comprising:
aligning a container of the storage box with an adapter assembly located on the track rail;
moving the container of the storage box toward the adapter assembly so that at least a portion of a rail mount coupled to the container enters into a cavity of the adapter assembly; and
rotating the container such that a portion of the rail mount engages a portion of the adapter assembly, the engagement between the rail mount and the adapter assembly opposing relative axial movement therebetween.

20. The method of claim 19, wherein before the step of aligning the container of the storage box with the adapter assembly, the method further comprises:
adjusting a position of the adapter assembly along the track rail; and
tightening a fastener to create a clamping force within the adapter assembly that opposes relative movement between the adapter assembly and the track rail.
